(19) United States
(12) Patent Application Publication
(10) Pub. No.: US 2012/0188595 A1
(43) Pub. Date: Jul. 26, 2012

(54) PRINT SPECIFICATION CONVERSION

(76) Inventors: Joseph Harold Teibel, Albany, OR (US); Jon Brewster, Monmouth, OR (US)

(21) Appl. No.: 13/013,388

(22) Filed: Jan. 25, 2011

(51) Int. Cl. G06F 3/12

(52) U.S. Cl. 358/1.15

(57) ABSTRACT

A method for print specification conversion performed by a print specification conversion system includes, with the print specification conversion system, receiving an electronic document, the electronic document comprising a first print specification, and with the print specification conversion system, converting the first print specification into a second print specification using a plug-in to the print specification conversion system, the plug-in designed for use with the first print specification. The second print specification is designed for use with a printing system associated with the print specification conversion system.

### BACKGROUND

Print service providers offer a variety of printing services to various types of customers. One service offered by many print service providers is a print-on-demand service. Print-on-demand services provide the customer with the ability to print a book as it is ordered instead of producing a particular number of books. This service, although slightly more costly per book, ensures that no extra copies of the book are produced. This eliminates the risk of wasteful production and storage costs.

Publishers typically store content to be published in an electronic document in a particular format such as Adobe's Portable Document Format (PDF). The content also includes print specifications that indicate how the content should be printed. These print specifications are specific to the printing equipment that will be printing the content. For example, a particular book printing system may require that each page leave a two inch margin on the left side of the page for binding purposes. The electronic document will then include a two inch margin on the left side of the content for each page.

Publishers and other entities who wish to print books and other content often use their own print specifications. These print specifications differ from those used by print service providers. Typically, when a print service provider partners with a publisher to print books, the print service provider will manually adjust the electronic document to comply with the print service provider's print specifications. This process is time consuming and costly. If a large number of books are printed from this electronic document, then the cost can be compensated for with the larger revenue brought in from sales of the printed books. However, if a smaller number of books are being printed, then this process is not cost effective.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative print specification conversion system, according to one example of principles described herein.

FIG. 2 is a diagram showing an illustrative print specification conversion process, according to one example of principles described herein.

FIGS. 3A and 3B are diagrams showing illustrative print specifications, according to one example of principles described herein.

FIG. 4 is a diagram showing an illustrative print specification conversion system as a web-based application, according to one example of principles described herein.

FIG. 5 is a flowchart showing an illustrative method for print specification conversion, according to one example of principles described herein.

Throughout the drawings, identical reference numbers designate similar, but not necessarily identical, elements.

### DETAILED DESCRIPTION

As mentioned above, publishers and other entities who wish to print books and other content often use their own print specifications. These print specifications differ from those used by print service providers. Typically, when a print service provider partners with a publisher to print books, the print service provider will manually adjust the electronic document to comply with the print service provider's print specifications. This process is time consuming and costly. If a large enough number of books is being printed from this electronic document, then the cost can be compensated for with the larger revenue brought in from sales of the printed books. However, if a smaller number of books are being printed, then this process is not cost effective. Alternatively, the print service provider can request that the publisher place the content into the print service provider's print specifications. However, this makes it less desirable for the publisher to want to do business with that print service provider.

In light of these and other issues, the present specification discloses a print specification conversion system that is capable of automatically converting an electronic document that uses one print specification to an electronic document that uses a different print specification. Specifically, the system is able to convert an electronic document from using the publisher's print specification to an electronic document that uses the print service provider's print specification.

According to certain illustrative examples, the print specification conversion system is configured to convert an electronic document from one print specification to another using plug-ins specifically designed for particular print specifications. A plug-in is a piece of software that provides additional and specific functionality to a larger piece of software. Each plug-in for the print specification conversion system is provided with important information about a particular print specification format. For example, if a publisher and a print service provider decide to do business, then the publisher can provide information about its own print specifications to the print service provider. The print service provider can then create a specific plug-in for that print specification. This plug-in provides an additional functionality to the print specification conversion system. Specifically, it can go through an electronic document and edit each page so that the converted electronic document now complies with the print service provider's print specification.

Through use of methods and systems embodying principles described herein, a print service provider doing business with multiple publishers can use a system that automatically converts the electronic documents from those publishers into a print specification used by the print service provider. This eliminates the cost of adjusting each electronic document manually. Additionally, it makes it more desirable for publishers to do business with that print service providers. Particularly because they can use that print service provider for smaller orders without the expense of a manually adjusting the electronic documents holding the content for those smaller orders or print-on-demand orders.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Throughout this specification and in the appended claims, the term “print specification” is to be broadly interpreted as a set of specifications relating to characteristics of an electronic document that are dependent upon the equipment to be used to print, bind, and/or trim a physical copy of that electronic document.

Throughout this specification and in the appended claims, the term “publisher” is to be broadly interpreted as any entity seeking to print content of an electronic document. The term “print service provider” is to be broadly interpreted as an entity capable of printing content. A print service provider may also bind, trim, or perform other tasks to bring the content within an electronic document into a book format.

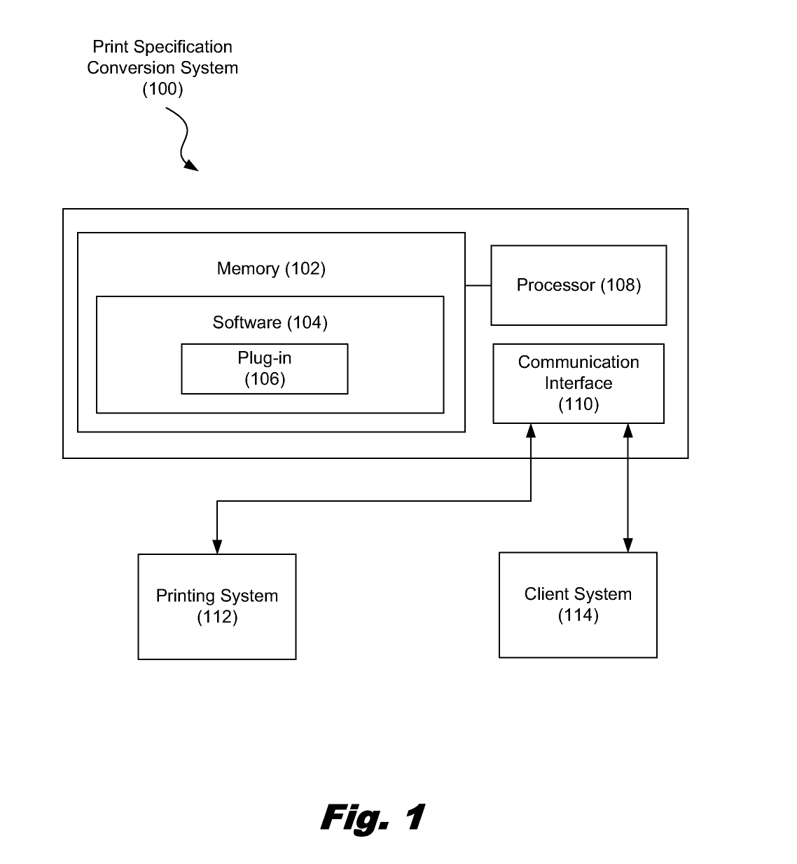

Referring now to the figures, FIG. 1 is a diagram showing an illustrative print specification conversion system (100). According to certain illustrative examples, the print specification conversion system (100) may include a memory (102) having software (104) stored thereon. The print specification conversion system (100) also includes a processor (108) and a communication interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The print specification conversion system (100) also includes a processor (108) for executing the software (104). The software (104) may include an operating system. An operating system allows other applications to interact properly with the hardware of the print specification conversion system. The software includes plug-ins (104) designed for converting electronic documents from different publishers' print specifications to the print service provider's print specifications.

A communication interface (110) may provide a means for other equipment to interact with the print specification conversion system (100). For example, the communication interface (110) may allow a client system (114) of a publisher to interact with the print specification conversions system (100). Specifically, the publisher can submit electronic documents for printing. Additionally, the communication interface can communicate with the printing system (112) that will be printing the electronic documents submitted by a publisher.

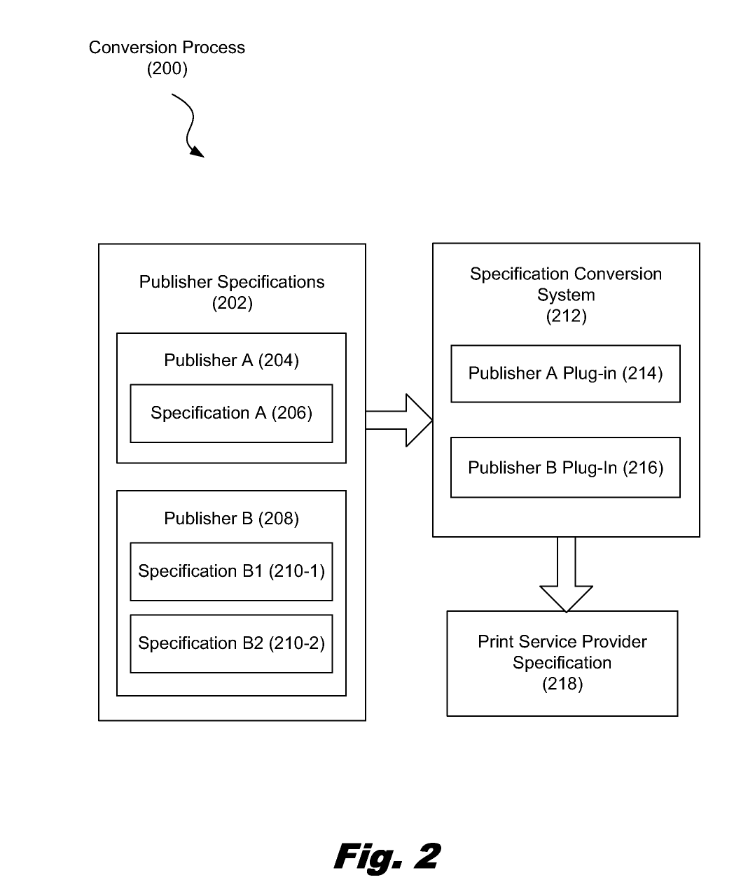

FIG. 2 is a diagram showing an illustrative print specification conversion process (200). As mentioned above, different entities such as publishers use their own print specifications. These publishers' specifications generally differ from the print specifications (218) used by a print service provider. Thus, the print specification conversion system (212) is used to convert an electronic document from using a publisher's print specification to the print service provider's print specification (218). The electronic document may be in a format such as a Portable Document Format (PDF). Alternatively, other document formats may be used. In some cases, the electronic document format may be a proprietary format used by the publisher. The print service provider may then be provided with a means of reading that format or converting documents of that format to an alternate format.

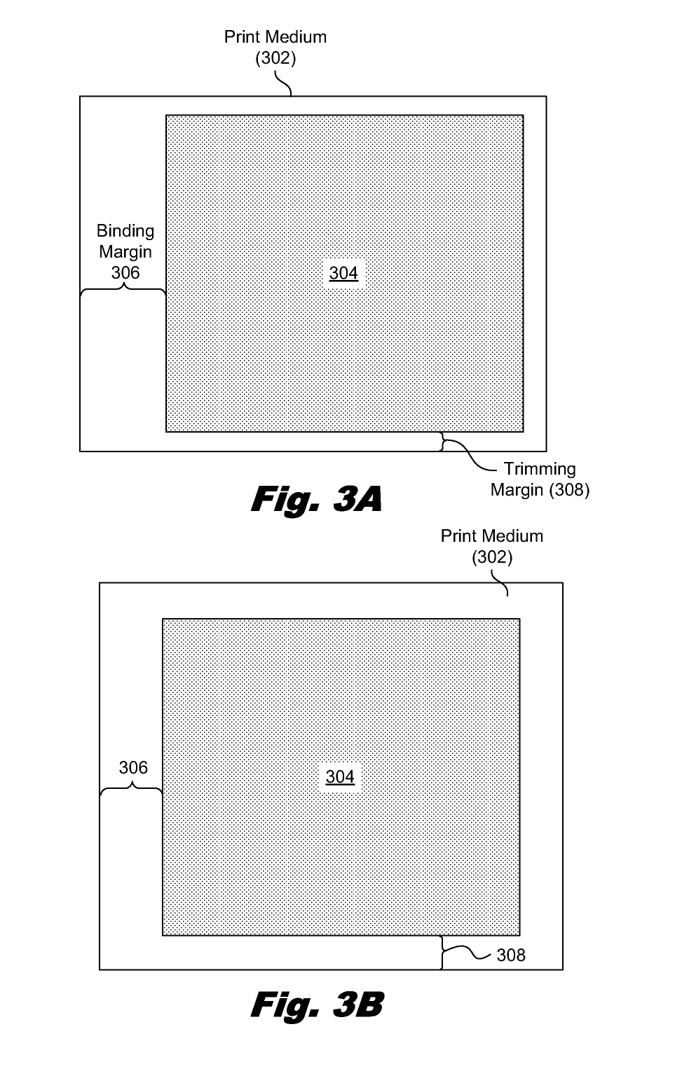

In one example, the print service provider engages in business with Publisher A (204). Publisher A uses print specification A (206). Publisher A provides the print service provider with the relevant information regarding print specification A (206). The print service provider can then create a plug-in (214) that is familiar with that relevant information. This plug-in gives the specification conversion system (212) the additional functionality of being able to convert electronic documents using print specification A (206) to an electronic document using the print service provider's specification. The newly converted electronic document includes the same content as it did before the conversion. The difference is that the converted electronic document has been adjusted so that when it is printed on the print service provider's equipment, it appears as the creator of the content intended. More detail and examples of print specifications will be discussed below in the text accompanying FIGS. 3A and 3B.

In some cases, a publisher may use more than one print specification. In a further example, Publisher B (208) uses print specification B1 (210-1) and print specification B2 (210-2). Publisher B can provide the print service provider with the relevant information for both of these print specifications (210-1, 210-2). The print service provider can then create a plug-in (216) that will allow the print specification conversion system (212) to convert electronic documents from either of these print specifications (210-1, 210-2) to the print service provider's print specification (218).

With these plug-ins (214, 216), the print specification conversion system (212) can readily accept electronic documents that are to be printed and bound into books. Neither the print service provider nor the publisher will have to make any manual changes to the electronic documents. Thus, the publisher will be able to print and bind smaller orders and print-on-demand orders without the added time and cost of manual adjustment.

In some cases, a publisher may provide an electronic document to a print service provider and that document may not completely comply with the publisher's own print specification. In this case, there will be errors in the conversion process. In some cases, the print service conversion system may utilize an error control system. This error control system can be configured to detect any discrepancies in the print specification of an electronic document. The error control system can then flag these discrepancies for manually checking and correcting. Additionally, for some errors, an auto-correction function may automatically correct the error.

FIGS. 3A and 3B are diagrams showing illustrative print specifications. FIG. 3A is a diagram showing a page of an electronic document using a first print specification. FIG. 3B is a diagram showing that same page of the electronic document using a second print specification. In one example, the first print specification corresponds to a publisher's print specification and the second print specification corresponds to a print service provider's print specification.

FIG. 3A illustrates content (304) placed onto a print medium (302). According to the first print specification, the placement of the content onto the print medium is such that there is a specific binding margin (306). This binding margin is such that it is compatible with the printing equipment to be used in accordance with the first print specification. For example, the binding equipment may require a particular margin of space on the left side of the content (304) in order to obtain the desired distance between the content (304) and the innermost visible part of the page after the binding occurs. Furthermore, the placement of the content is such that there is a specific trimming margin (308) on all edges of the content. This trimming margin ensures that the desired distance between any trimming done to the print medium and the content is as intended for the final book product.

FIG. 3B illustrates the same page of content using a different print specification. According to this second print specification, the binding margin is slightly smaller and the trimming margins are slightly larger. This may be because the printing equipment to be used in accordance with the second print specification has a binding process that requires less room on the left margin of the page. Additionally, the trimming process used by this same equipment may be designed so that more paper is trimmed during the trimming process. Thus, to preserve the desired margins around the content, more space around the edges is required.

The examples shown above are only some print specifications that may need to be changed when converting from a publisher's print specification to a print service provider's print specification. Other print specifications may be changed as well including specifications for the front and back cover of the book.

In some cases, the print specification conversion system may convert print specifications for various print products other than books. For example, the print specification conversion system may convert print specifications for banners, posters, and other signage products. Additionally, the print specification conversion system may be used for pamphlets, flyers and other small print products.

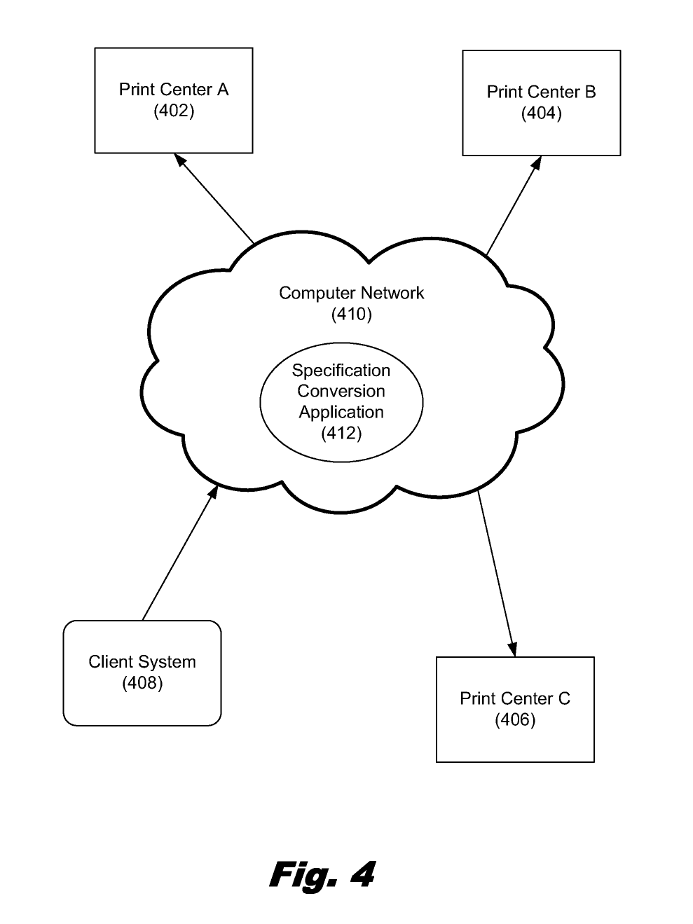

FIG. 4 is a diagram showing an illustrative print specification conversion system as a web-based application. According to certain illustrative examples, the print specification conversion system may be available to publishers over a computer network (410). In this example, a publisher may use a client system (408) to submit an electronic document to the print specification conversion application (412). After converting the print specification of the electronic document to the print service provider's print specification, the specification conversion application will then transmit the converted electronic document to one of the print centers (402, 404, 406). The print center receiving the electronic document may then print the order as requested by the publisher. Alternatively, if the electronic document is for a print-on-demand book, the specification conversion application may store the electronic document for use when an order is made. In some cases, one of the print centers may store the converted electronic document until orders are made for a printed copy of that electronic document.

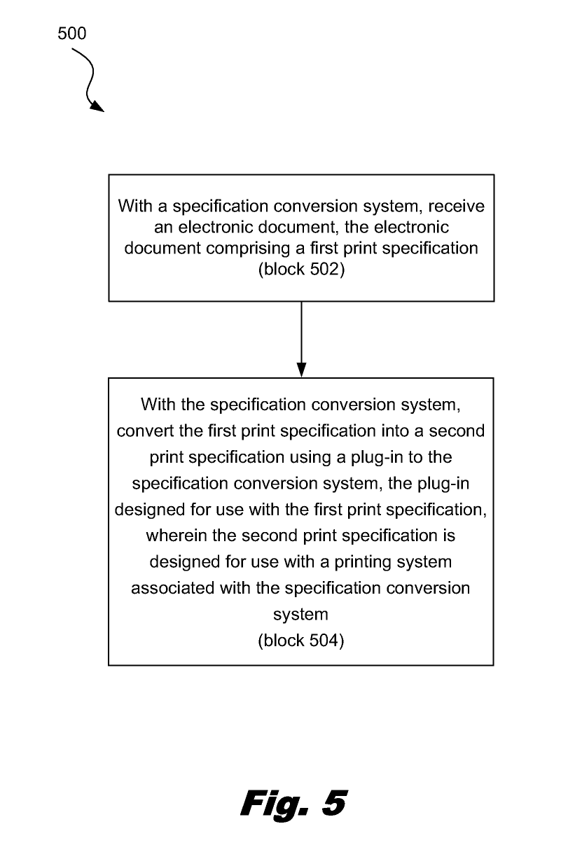

FIG. 5 is a flowchart showing an illustrative method for print specification conversion. According to certain illustrative examples, the method includes, with a specification conversion system, receiving (block 502) an electronic document, the electronic document comprising a first print specification, and with the specification conversion system, converting (block 504) the first print specification into a second print specification using a plug-in to the specification conversion system, the plug-in designed for use with the first print specification, wherein the second print specification is designed for use with a printing system associated with the specification conversion system.

In conclusion, through use of methods and systems embodying principles described herein, a print service provider doing business with multiple publishers can use a system that automatically converts the electronic documents from those publishers into a print specification used by the print service provider. This eliminates the cost of adjusting each electronic document manually. Additionally, it makes it more desirable for publishers to do business with that print service providers. Particularly because they can use that print service provider for smaller orders without the expense of a manually adjusting the electronic documents holding the content for those smaller orders or print-on-demand orders.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for print specification conversion performed by a print specification conversion system, the method comprising:
with said print specification conversion system, receiving an electronic document, said electronic document comprising a first print specification; and
with said print specification conversion system, converting said first print specification into a second print specification using a plug-in to said specification conversion system, said plug-in designed for use with said first print specification;
in which said second print specification is designed for use with a printing system associated with said print specification conversion system.

2. The method of claim 1, further comprising, with said printing system, printing said electronic document having been converted to said second print specification format.

3. The method of claim 2, in which said electronic document is received from an entity, said first print specification being used by said entity.

4. The method of claim 2, in which said second print specification format is used by a print service provider operating said print specification conversion system.

5. The method of claim 1, wherein said plug-in comprises an error handling function to determine if said electronic document complies with said first print specification.

6. The method of claim 5, further comprising, automatically correcting errors found by said error handling function.

7. The method of claim 1, wherein said print specification conversion system comprises a closed system associated with said printing system.

8. The method of claim 1, wherein said print specification conversion system comprises a web-based service communicatively coupled to said printing system.

9. A print specification conversion system comprising:
a processor; and
a memory communicatively coupled to said processor; and
in which said processor is to:
receive an electronic document using a first print specification; and
convert said first print specification into a second print specification using a plug-in to said print specification conversion system, said plug-in being designed specifically for converting said first print specification to said second print specification;
in which said second print specification is designed for use with a specific printing system communicatively connected to said print specification conversion system.

10. The system of claim 9, in which said processor is further to print said electronic document with said printing system.

11. The system of claim 9, in which said electronic document is received from an entity, said first print specification being used by said entity.

12. The method of claim 9, wherein said plug-in comprises an error handling function to determine if said electronic document complies with said first print specification.

13. The system of claim 12, further comprising, automatically correcting errors found by said error handling function.

14. The system of claim 9, in which said print specification conversion system comprises one of: a closed system associated with said printing device and a web-based service communicatively coupled to said printing system.

15. A computer program product for managing providing a layout for graphic objects, said computer program product comprising:
a computer readable storage medium having computer readable code embodied therewith, said computer readable program code comprising:
computer readable program code configured to receive an electronic document, said electronic document comprising a first print specification; and
computer readable program code configured to convert said first print specification into a second print specification using a plug-in to said print specification conversion system, said plug-in comprising computer readable program code specifically designed to be compatible with said first print specification;
in which said second print specification is designed for use with a specific printing system communicatively connected to said print specification conversion system.
